(19) United States
(12) Patent Application Publication
(10) Pub. No.: US 2002/0138279 A1
(43) Pub. Date: Sep. 26, 2002

(54) On-line digital imaging services

(76) Inventors: Binnur Al-Kazily, Star, ID (US); Craig R. White, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/814,300

(22) Filed: Mar. 21, 2001

(51) Int. Cl. G06F 17/60; G06F 15/16

(52) U.S. Cl. 705/1; 709/203

(57) ABSTRACT

Methods and systems for promoting communications between a web-enabled digital imaging device and an on-line digital imaging services site are provided. In accordance with embodiments of the system, the device at least includes a microcontroller for executing client-ware and memory for storing a set of information defining a user profile. The user profile includes identification and preference information that is utilized to establish a connection between the device and the imaging services site, and to automatically perform certain imaging services.

### FIELD OF THE INVENTION

The invention relates to methods and systems for on-line imaging services and, particularly, to a system and method for providing direct communication between an imaging device and an on-line imaging service provider.

### COPYRIGHT & TRADEMARK NOTICE

A portion of the disclosure of this patent document contains material which is subject to copyright protection. The owner has no objection to the facsimile reproduction by any one of the patent document or the patent disclosure, as it appears in the Patent and Trademark Office patent file or records, but otherwise reserves all copyrights whatsoever. Certain marks referenced herein may be common law or registered trademarks of third parties affiliated or unaffiliated with the applicant or the assignee.

### BACKGROUND

### RELATED ART

With the advancements in on-line communications and digital technology, electronic services are available that allow a person to take and post photographs on the Internet using a digital camera. To do this, typically, the person after taking photographs with a digital camera needs to connect the digital camera to a personal computer system connected to the Internet. Image information stored on the camera is then loaded to the personal computer. Thereafter, the information is forwarded to an e-commerce imaging service selected by the user on the internet.

Currently, computer software is available that can be executed on a personal computer to retrieve and communicate image information stored on a digital camera to selected imaging services on the Internet. As such, current digital imaging devices depend on personal computers to interact with the available on-line imaging services to perform tasks such as posting images on an Internet site, and ordering reprints, for example. To execute these tasks, a person is required to manually interact with a personal computer system to load the information from camera to the personal computer. Furthermore, a user will have to manually navigate through multi-level menus on Internet imaging sites to select or configure options for services available.

With advancements in digital technology, new digital cameras are available that are web-enabled. A web enabled digital camera can connect to the Internet, for example, by dialing into an Internet Service Provider (ISP). Unfortunately, however, there is no communication model available that allows a digital camera to directly communicate with an on-line imaging service to access the available service.

It would be very useful if a person could connect a digital camera directly to the Internet and upload image information into a desired site in a particular format and arrangement. Furthermore, it is desirable to be able to automatically access and select imaging services available on the Internet without the necessity of connecting the digital camera to a personal computer.

### SUMMARY

In accordance with this invention, a method and system for promoting communications between a web-enabled digital imaging device and an on-line digital imaging services site is provided. In accordance with embodiments of this invention, the device at least includes a microcontroller for executing code and memory for storing a set of information defining a user profile. The user profile includes identification and preference information that is utilized to establish a connection between the device and the imaging services site and to automatically perform certain imaging services.

A user can create and or update a previously created profile on the device by connecting the device to a computing system, such as a personal computer, and executing setup software on the computing system. The setup software either automatically or as the result of user interaction with the computing system gathers certain identifying information about the device and the user in addition to preference information about the imaging services requested by the user.

For example, identifying information includes user name, password, payment information, and information such as the device serial number that uniquely identifies the imaging device. Preference information can be programmed by the user to set out the manner and location for storing, displaying, printing, or forwarding images on-line, for example. The setup software stores the information in the device's memory to create or update the user profile.

In accordance with one aspect of the invention, the device is connected to the Internet directly via a wired or wireless communication port. Based on the information stored in the user profile, code executed on the device establishes a connection between the device and an on-line imaging services site and uploads any images stored in the device. A user interacting with the device causes the code executing on the device to submit requests for services to the imaging services site. Code executing on the imaging services site services requests submitted by the device in accordance with information stored in the user profile.

In certain embodiments, the user profile may be partly stored on the imaging services site. Further, the code executed on the client and server systems described above may be in form of software or firmware.

### BRIEF DESCRIPTION OF DRAWINGS

FIG. 1 is a block diagram of the on-line system of the invention, in accordance with one or more embodiments.

FIG. 2 is a flow diagram illustrating a method of accessing on-line imaging services, in accordance with one or more embodiments of the invention.

FIG. 3 is a flow diagram illustrating a method of updating a user profile on a web-enabled imaging device in accordance with one or more embodiments of the invention.

### DETAILED DESCRIPTION

In the following numerous specific details are set forth to provide a thorough description of embodiments of the invention. Of course, the invention may be practiced without certain specific details or with some variations in detail.

One or more embodiments of the system provide on-line imaging services to a web-enabled imaging device directly connected to the Internet. In accordance with one aspect of the system, the imaging services are provided by an on-line service provider. A service provider is an entity to which a consumer can subscribe in order to take advantage of the electronic services offered, in accordance to one or more aspects of the invention.

### SYSTEM ARCHITECTURE

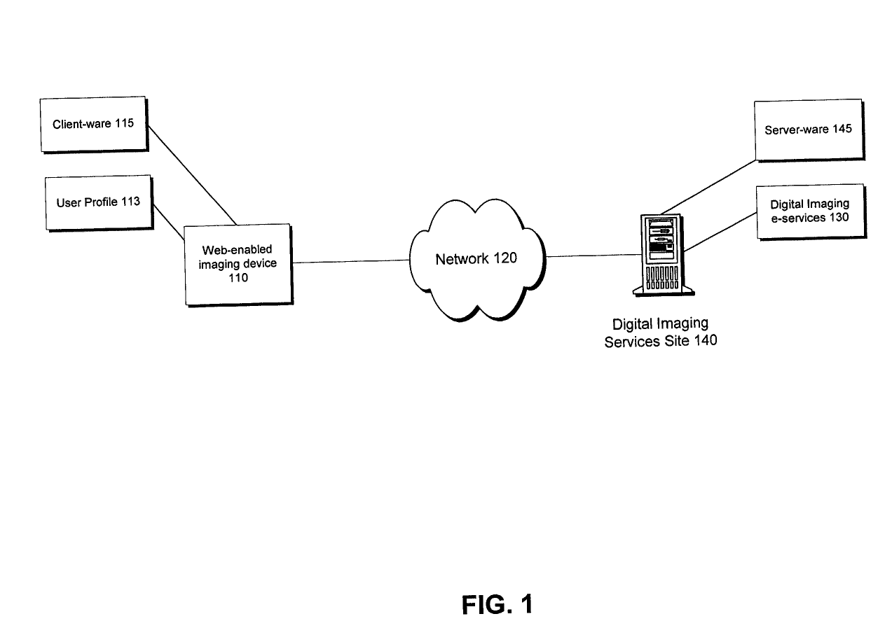

FIG. 1 illustrates the system's environment, in accordance to one or more embodiments of the invention. As shown, a web-enabled digital imaging device 110 (hereinafter device 110) is connected to an on-line digital imaging services site 140 (hereinafter services site 140) through a network 120. Network 120 can be any type of communications network, including the Internet. Digital imaging electronic services 130 (hereinafter imaging e-services 130) are provided by a service provider that maintains and or operates services site 140. An example of a currently available electronic imaging service provider is Hewlett-Packard (HP) Cartogra. Cartogra provides a subscriber with services including uploading, storing, displaying, arranging, and printing digital images.

Device 110 can be a digital camera that connects to communications network 120 in a well-known manner via a communications port, for example. A communications port is a pathway into and out of a network device and can be implemented as a network adapter available in a kiosk, for example. The kiosk can be placed in an amusement park or street comer, for example, where there is a need for it. Wired or wireless communication ports may be utilized to implement points of interface. Examples of wireless technologies that can be used to provide a communication interface between device 110 and network 120 include IrDA, and Bluetooth. IrDA is a standard developed by Infrared Data Association, Walnut Creek, Calif., that provides for infrared communication between various computing systems, for example a digital camera and a communications port. With IrDA ports, device 110 can transfer image data to a receiving port without a cable connection. IrDA requires line-of-sight transmission.

In alternate embodiments of the system, wireless connections can be established by incorporating communication interfaces that promote the exchange of information using radio (RF) technology, such as Bluetooth™. Bluetooth is a wireless personal area network (PAN) technology from the Bluetooth Special Interest Group (founded by Ericsson, IBM, Intel, Nokia and Toshiba). Bluetooth is an open standard for short-range transmission of digital voice and data between mobile devices (e.g., digital cameras, PDAs, phones, etc.). Unlike IrDA which requires a line-of-sight transmission, Bluetooth uses omni-directional radio waves that can transmit through walls and other non-metal barriers.

Other wireless standards and technologies, such as IEEE 802.11, may be used in other embodiments of the system. Wired technologies such as Universal Serial Bus™ (USB) or Firewire™ (IEEE Standard 1394) may be utilized to provide a physical connection between device 110 and a communications port. USB is a hardware interface that provides a means of communication between various devices. Device 110 may be implemented to include a USB port for connecting to network 120. Firewire is a communication standard in conjunction with a high-speed serial bus developed by Apple and Texas Instruments that allows for high-speed transfer of information between devices attached to a network.

Device 110 can be a web-enabled digital camera, such as the Panasonic PalmCam PV-DC2590. The Panasonic PV-DC2590 PalmCam features a 1.3-Megapixel CCD (that generates 1280×960 images), a 1.8″ color LCD, 3× optical zoom lens, dual CompactFlash card slots, and a Compact Modem. The PalmCam can utilize the modem to connect to the Internet by dialing into an ISP via a telephone line, for example. Other web-enabled digital imaging devices are available or can be implemented that include one or more communication ports for direct connection to the Internet.

Device 110 also includes a microcontroller, a memory, and software or firmware that can be executed by the microcontroller to establish a connection and to communicate with imaging services site 140. Various communication protocols, such as HyperText Transport Protocol (HTTP), can be used to establish a connection between device 110 and imaging services site 140. Various programming languages, such as EXtensible Markup Language (XML) or HyperText Markup Language (HTML) can be used to implement a communication interface between device 110 and imaging services site 140.

This invention will be more fully understood by the following description of the hardware and software components of the system.

### SYSTEM SOFTWARE OR FIRMWARE

As illustrated in FIG. 1, in one or more embodiments of the invention, system software or firmware, herein referred to as client-ware 115, is executed on device 11O's microcontroller to control device functionality and to communicate with imaging services site 140. Application software or firmware, hereinafter referred to as server-ware 145, is executed on imaging services site 140 to provide digital imaging e-services 130. Client-ware 115 submits requests for performance of digital imaging e-services 130. Server-ware 145 services the requests submitted by client-ware 115.

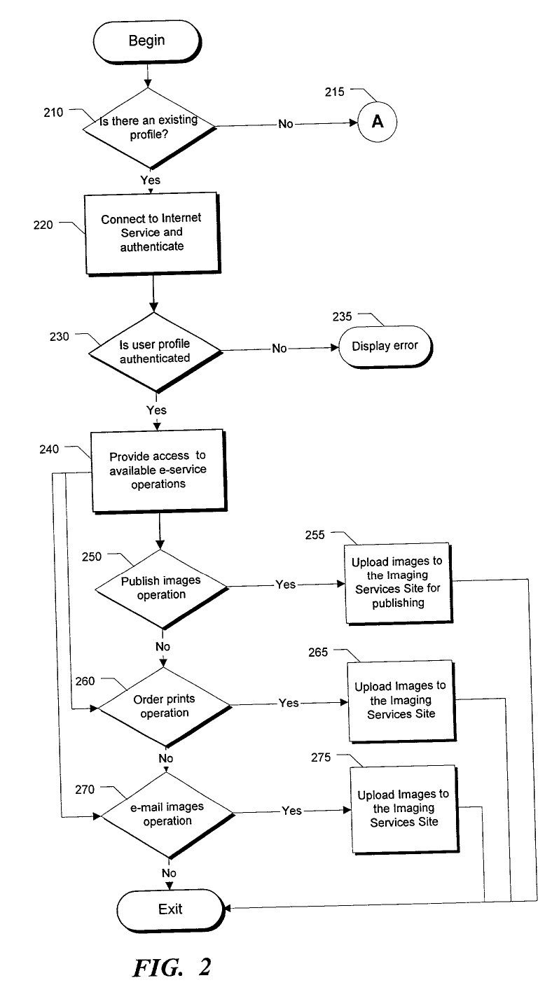

FIG. 2 is a flow diagram illustrating a method by which client-ware 115 causes device 110 to communicate with digital imaging services site 140, before and after device 110 is connected to imaging services site 140. At step 210, in accordance with one aspect of the system, client-ware 115 determines whether a user profile 113 is stored in device 110. Device 110 includes memory or other type of storage medium for storing user profile 113. User profile 113 is a set of information that includes identifying and preference information. This user profile stored in device 110 is accessible by client-ware 115 and can be retrieved from the storage device and included in a request forwarded to imaging services site 140. It is noteworthy that in certain embodiments of the invention, user profile 113 is in part stored on imaging services site 140. In such an embodiment, the portion of user profile 113 that is stored on device 110 includes identifying information to reference the portion of user profile 113 that may be stored on imaging services site 140. Using the information included in user profile 113, server-ware 145 identifies the user's and device 11 0's requirements and the nature of imaging services that are to be provided in accordance with a user's request.

Information stored in user profile 113 includes the Internet address (i.e., the Uniform Resource Locator (URL) of imaging services site 140) that provides digital imaging services 130. Other information stored in user profile 113 can include user name or user ID, password, device 110's unique serial number, manufacturer information, and other information that uniquely identifies the user or device 110. In accordance with some embodiments of the system, some or all of the named information can be accessed via the communication port (e.g., a USB port) to which device 110 attaches. This information can be accessed automatically as soon as the connection of device 110 to the communication port is detected in a manner well-known in the art. The accessed information can be then transmitted to server-ware 145 for processing.

User profile 113 can further include user preferences for the format and options available for a particular on-line account. These preferences may include the specific or alternative services sites to which a user subscribes, the on-line location in which a user wishes to publish or store his or her images, a list of addressees to whom a user wishes to forward certain images, the manner of publication and display of images on the services site or other preferred site, the format or number of prints for submitted images, user information such as name, last name, address, payment information, device related information, and other particulars.

If a user profile is not stored on device 110, then at step 215 a user profile can be created, as described in further detail below. Otherwise, at step 220, client-ware 115 submits a request to establish a connection with imaging services site 140 and proceeds to authenticate with server-ware 145 by submitting uniquely identifying information (e.g., device serial number, user ID, password) stored in user profile 113.

At step 230, server-ware 145 determines whether authentication information submitted by client-ware 115 is sufficient to allow for a connection to be established between device 110 and imaging services site 140. If authentication fails, then at step 235, an error is displayed. If authentication is successful, at step 240, server-ware 145 forwards a response to client-ware 115 and provides the user with access to available digital imaging e-services 130. In embodiments of the system, user access is provided via a menu driven user interface that is controllable by one or more buttons available on device 110. However, other implementations are possible.

For example, device 110 may include a Liquid Crystal Display (LCD) screen, or other type of display screen for displaying a Graphic User Interface (GUI). By interacting with the GUI a user can select from the provided menus displayed on the screen. Thus, for example, a user can use a stylus to select certain options from a GUI, or alternatively the user interface may be implemented such that a user can press one or more buttons on device 110 in order to select certain options.

Depending on implementation, the user may be able to select from a number of different services provided by digital imaging e-services 130. For example, at step 250, a user can interact with the provided menu to select an option for publishing images on the Internet. If the user selects this option, then client-ware 115 uploads digital images stored in device 110 to the imaging services site 140 for publishing, at step 255. The method of uploading information to an on-line service site is well-known.

Once the images are uploaded, server-ware 145 arranges the uploaded images in a format in accordance with the preferences set out in user profile 113. Preference information can be uploaded along with the images, or can be retrieved before or after the images are uploaded, in accordance with one or more embodiments of the system. For example, in some embodiments, a user preference may be for the images to be displayed in a photo album layout. The preference may also include information about a user's choice for a specific layout arrangement. Other preference options may be set to allow or prohibit certain people to view or download images from services site 140. Other services and options are possible, as well.

In one or more embodiments of the system, a user at step 260 can choose to order prints of images uploaded to imaging services site 140, at step 255. Alternatively, the user may skip step 250, and select the option for printing images at step 260, directly. If the user selects this option, then at step 265 client-ware 115 uploads images to the imaging services site 140 for ordering prints. Upon receiving this print order, server-ware 145 examines the preferences set out in user profile 113 to determine the print size and format. For example, a user may have configured his or her user profile to indicate the preferred photo sizes or the number of prints for uploaded images to digital imaging e-services 130.

In accordance with another aspect of the system, at step 270, a user can select an option to email images to one or more recipients. If the user chooses this option then at step 275 client-ware 115 uploads images to the imaging services site 140. If the images have been previously uploaded then step 275 is skipped. Server-ware 145 upon receiving the email request examines the user profile to determine if an email address list for the recipients exists. If so, server-ware 145 examines the email addresses of the recipients of the images and forwards the images to them. In accordance with one or more aspects of the system, information stored in user profile 113 is retrieved and forwarded to server-ware 145 on an as-needed basis. In alternative embodiments, all information in user profile 113 is read and forwarded to server-ware 145 sometime after device 110 establishes a connection with services site 140.

In certain embodiments of the system, device 110 includes a viewing screen that can provide the user with access to imaging services site 140 in such a way that the user can interact with the site by using either GUI or other interface tools such as buttons. If a viewing screen is included, then the user is provided with additional options and can view the images that are uploaded on the Internet, for example. The user, in certain embodiments, by interacting with device 110's interfaces can select one or more images that he or she wishes to publish, order, or forward before or after the images are uploaded.

### SETTING UP A USER PROFILE

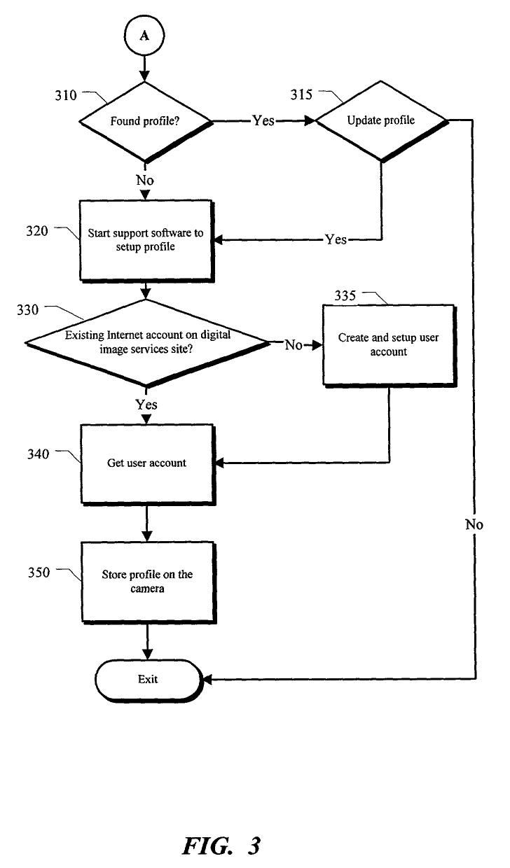

If a user profile is not stored on device 110, then the user creates and stores the user profile on device 110. To accomplish this, the user connects device 110 to a computing device, such as a personal computer (PC). The connection can be established in a well known manner. FIG. 3 illustrates a flow diagram for a method of setting up and/or updating a user profile on a web enabled digital imaging device, in accordance to one or more embodiments of the invention.

In some embodiments, support software can be executed on the PC that allows the user to enter the required information to set up a user profile. Once device 110 is connected to the PC, the user can search for an existing profile stored on device 110. At step 310, if a profile is found, then the user can select the existing user profile and at step 315 the user can choose to update the user profile. If the user chooses not to update the user profile then the existing profile stored on device 110 remains intact.

If no profile exists or if the user decides to update the existing profile on device 110, then at step 320, the user executes the support software on the PC. The support software interacts with device 110 to retrieve necessary device information from device 110. At this step, certain identifying information such as the serial number and model of device 110 is retrieved from device 110 and included in the user profile. This information is used to uniquely identify device 110 when client-ware 115 tries to authenticate and/or establish a connection with imaging services site 140.

Once the necessary identifying information is retrieved from device 110, at step 330, it is determined whether there is an established Internet account with a digital imaging service site. If an account does not exist, then at step 335 the user creates and sets up a user account by using the support software running on the PC. The user can accomplish this by going to a selected Internet digital imaging service site that offers digital imaging e-services. The user can then choose various services provided by the service (e.g., publishing, printing, forwarding, etc.). The user can further enter user preferences for each available service (e.g., publishing format, printing style, number of prints, email addresses for forwarding images).

After the user sets up an on-line account with an imaging services site of his or her choice, or if the user already has an established account, then at step 340, specific account information is obtained by the support software. This information includes user information (e.g., user name, password, credit card number, address), the site address for the imaging e-service with which the user has established an account, and other information needed for providing imaging services, as discussed in detail earlier. At step 350, the user profile is updated based on information received as a result of executing the set up software. The updated user profile containing all the needed information is stored on device 110.

It should be understood that specific system configurations and implementations are disclosed here by way of example and other embodiments of this invention will be apparent to those skilled in the art in view of this disclosure. Other system architectures, platforms, and implementations that can support various aspects of the invention may be utilized. Thus, a system and method for automatically accessing on-line digital imaging services using a web-enabled digital imaging device is described in conjunction with one or more specific embodiments. These and various other adaptations and combinations of features of the embodiments disclosed are within the scope of the invention. The invention is defined by the claims and their full scope of equivalents.

1. An on-line system for providing imaging services comprising:
client-ware running on a web-enabled imaging device for submitting requests for imaging services available on an on-line imaging services site; said device including a user profile containing information associated with said imaging services.

2. The system of claim 1 wherein said information contained in the user profile includes identifying information.

3. The system of claim 2 wherein said information contained in the user profile further includes preferences for the available services.

4. The system of claim 3 wherein the services on-line imaging site includes server-ware for servicing the requests submitted by the client-ware for imaging services.

5. The system of claim 4 wherein the server-ware services a request submitted by the client-ware based on information included in the user profile.

6. The system of claim 5 wherein the client-ware transfers one or more images to the server-ware.

7. The system of claim 6 wherein the client-ware submits a request for said one or more images to be published on-line in accordance with information contained in the user profile.

8. The system of claim 6 wherein the client-ware submits a request for said one or more images to be printed in accordance with information contained in the user profile.

9. The system of claim 6 wherein the client-ware submits a request for said one or more images to be electronically forwarded to one or more recipients in accordance with information contained in the user profile.

10. The system of claim I wherein the user profile is partly stored on the on-line imaging services site.

11. A user profile stored in a web-ready imaging device, for accessing digital imaging services available on an on-line digital imaging services site.

12. The user profile of claim 11 comprising information identifying the on-line digital imaging services site.

13. The user profile of claim 11 comprising account information for authenticating against the on-line digital imaging services site.

14. The user profile of claim 13 wherein the account information includes unique identification information for uniquely identifying a user account on the on-line digital imaging services site.

15. The user profile of claim 11 comprising user preference information regarding the manner of publishing one or more images on the on-line digital imaging services site.

16. The user profile of claim 1 1 comprising user preference information regarding printing one or more images uploaded to the on-line digital imaging services site.

17. The user profile of claim 11 comprising user preference information regarding electronically forwarding one or more images uploaded to the on-line digital imaging services site to one or more recipients.

18. A method of providing on-line imaging services in a system comprising a digital imaging services site and web-enabled imaging device including a user profile, said method comprising:
connecting the web-enabled imaging device directly to an Internet service provider;
establishing a connection between the imaging services site designated in the user profile and the device;
submitting a request generated by the device for imaging services to the digital imaging services site;
examining the user profile for information pertaining to the submitted request at the imaging services site, in response to said request; and
providing one or more imaging services in accordance with the submitted request and information included in the user profile.

19. The method of claim 18, further comprising:
submitting identifying information included in the user profile to the imaging services site to access digital imaging services available on the imaging services site;
receiving permission to access the available digital imaging services in response to submitting identifying information; and
transferring one or more images stored in the web-enabled imaging device to the imaging services site.

20. The method of claim 19, wherein the submitted request by the web-enabled imaging device is to store said one or more transferred images in an on-line location in accordance with information included in the user profile.
